(19) United States
(12) Patent Application Publication
(10) Pub. No.: US 2017/0371279 A1
(43) Pub. Date: Dec. 28, 2017

(54) LINEAR LIGHT-CONCENTRATING DEVICE, FIXING DEVICE, AND IMAGE FORMING APPARATUS

(71) Applicant: FUJI XEROX Co., Ltd., Tokyo (JP)

(72) Inventor: Yoshiya IMOTO, Kanagawa (JP)

(73) Assignee: FUJI XEROX Co., Ltd., Tokyo (JP)

(21) Appl. No.: 15/374,553

(22) Filed: Dec. 9, 2016

(30) Foreign Application Priority Data
Jun. 24, 2016 (JP) 2016-125645

(51) Int. Cl. G03G 15/20

(52) U.S. Cl. CPC G03G 15/2007

(57) ABSTRACT

A linear light-concentrating device includes: a light-emitting body having light-emitting surfaces; a first optical element group; a second optical element group having apertures; and a light-transmitting columnar member. The first optical element group is divided into first optical elements each having a deflecting characteristic that causes an incident beam to be converted to an exit beam deflected in a first direction. The second optical element group is divided into second optical elements. The first optical elements include constituent units each including at least two of the first optical elements, and the deflecting characteristics of the first optical elements are such that a group of exit beams from each of the constituent units is deflected toward a corresponding one of the apertures of the second optical element group. The optical axes of the second optical elements are decentered toward the optical axis of the columnar member.

### CROSS-REFERENCE TO RELATED APPLICATIONS

This application is based on and claims priority under 35 USC 119 from Japanese Patent Application No. 2016-125645 filed Jun. 24, 2016.

### BACKGROUND

### Technical Field

The present invention relates to a linear light-concentrating device, a fixing device, and an image forming apparatus.

### SUMMARY

According to an aspect of the invention, there is provided a linear light-concentrating device including: a light-emitting body that has plural light-emitting surfaces arranged in two directions; a first optical element group; a second optical element group having plural apertures, the first optical element group and the second optical element group being disposed at different positions with respect to an emission direction of the light-emitting body; and a light-transmitting columnar member that has an optical axis, is disposed on an exit side of the second optical element group, and extends in a first direction. The first optical element group is divided in the first direction and a second direction different from the first direction into plural first optical elements. Each of the first optical elements has a deflecting characteristic that causes an incident light beam from the light-emitting body to be converted to an exit light beam deflected in the first direction. Adjacent ones of the first optical elements that are adjacent in the second direction have different deflecting characteristics in the first direction. At least one side of the second optical element group is divided at least in the first direction into plural second optical elements each having an optical axis and having optical power in the second direction, and the optical axes of adjacent ones of the second optical elements have different heights in the second direction. The first optical elements include plural constituent units each including at least two of the first optical elements that are continuous in the first direction, and the deflecting characteristics of the first optical elements are such that a group of exit light beams from each of the constituent units is deflected toward a corresponding one of the apertures of the second optical element group. The length of the second optical elements in the second direction is larger than the length of the first optical elements in the second direction. The optical axis of each of the second optical elements is decentered in the second direction from a central positon, with respect to the second direction, of a corresponding one of the first optical elements. The optical axes of the second optical elements are decentered toward the optical axis of the columnar member.

### BRIEF DESCRIPTION OF THE DRAWINGS

An exemplary embodiment of the present invention will be described in detail based on the following figures, wherein:

FIG. 1 is a front view of an image forming apparatus to which an exemplary embodiment of the present invention is applied;

FIG. 2 is an illustration showing a schematic configuration of a fixing device;

FIG. 3 is an illustration showing a light-concentrating device of the fixing device;

FIG. 4 is an illustration showing a surface-emitting laser unit;

FIG. 5 is a perspective view illustrating a bundle optical system;

FIG. 6A is a perspective view illustrating guidance of light from an (n−1)th stage in the bundle optical system;

FIG. 6B is a perspective view illustrating guidance of light from an n-th stage in the bundle optical system;

FIG. 6C is a perspective view illustrating guidance of light from an (n+1)th stage in the bundle optical system;

FIG. 7 is a perspective view illustrating the bundle optical system;

FIG. 8 is an illustration showing sawtooth optical elements in a first optical element group;

FIG. 9 is an illustration showing the correspondence between bundles of light beams and block cylinder elements in a second optical element group;

FIG. 10A is an illustration showing the correspondence between a bundle of light beams from the 20-th stage and a block cylinder element in the second optical element group;

FIG. 10B is an illustration showing the correspondence between bundles of light beams from the 19-th stage and block cylinder elements in the second optical element group;

FIG. 10C is an illustration showing the correspondence between bundles of light beams from the 18-th stage and block cylinder elements in the second optical element group;

FIG. 10D is an illustration showing the correspondence between bundles of light beams from the 17-th stage and block cylinder elements in the second optical element group;

FIG. 11 is an illustration showing the correspondence between bundles of light beams and block cylinder elements in the second optical element group;

FIG. 12A is an illustration showing the correspondence between a bundle of light beams from the 16-th stage and a block cylinder element in the second optical element group;

FIG. 12B is an illustration showing the correspondence between a bundle of light beams from the 15-th stage and a block cylinder element in the second optical element group;

FIG. 12C is an illustration showing the correspondence between bundles of light beams from the 14-th stage and block cylinder elements in the second optical element group;

FIG. 12D is an illustration showing the correspondence between bundles of light beams from the 13-th stage and block cylinder elements in the second optical element group;

FIGS. 13A to 13C are illustrations showing the curvatures of unit column cylinders, the curvatures being different from each other;

FIG. 14 is a schematic perspective view illustrating decentering of block cylinder elements in the second optical element group;

FIG. 15A is a schematic perspective view illustrating light concentration on a transparent rod through decentered block cylinder elements in the second optical element group;

FIG. 15B is a table showing the comparison between before and after decentering the sub-direction SD positions of the optical axes of block cylinder elements;

FIG. 16A is a perspective view of sawtooth optical elements in the first optical element group, showing correction of skew aberration;

FIG. 16B is a perspective view of the first optical element group and the second optical element group; and

FIG. 17 is a graph showing the correction of skew aberration, the vertical axis representing a surface inclination angle (deg) of a first optical element with respect to a sub-direction SD, the horizontal axis representing an incident angle in a main-direction MD (deg) on a block cylinder element.

### DETAILED DESCRIPTION

An exemplary embodiment of the invention will next be described in detail with reference to the accompanying drawings.

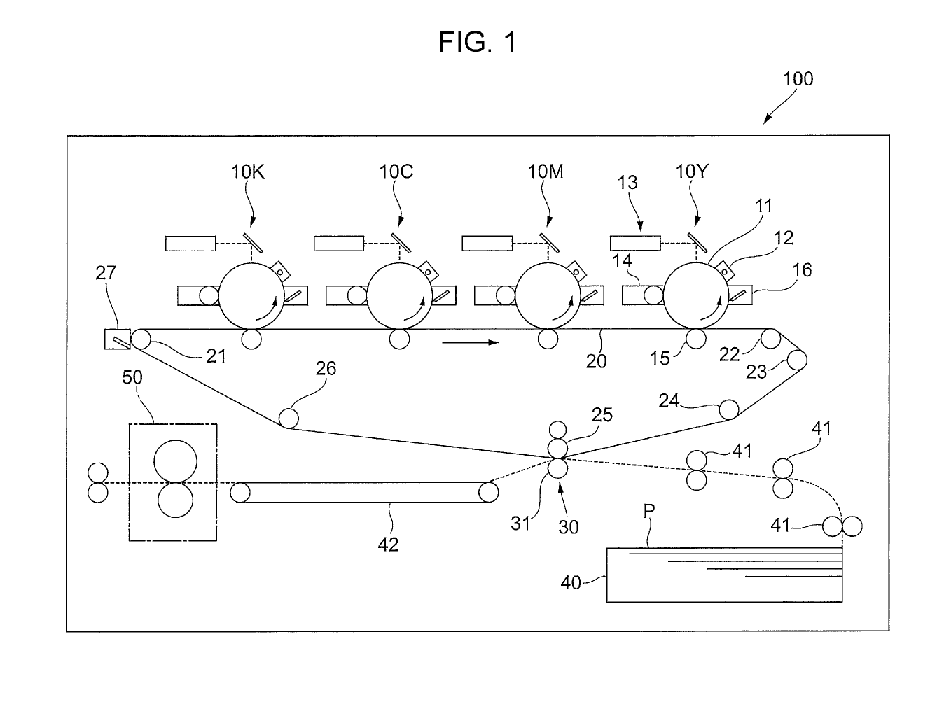

FIG. 1 is a front view of an image forming apparatus 100 to which the present exemplary embodiment is applied.

The image forming apparatus 100 shown in FIG. 1 has a so-called tandem configuration and includes plural image forming units 10 (10Y, 10M, 10C, and 10K) that form toner images of different colors by an electrophotographic process. The image forming apparatus 100 according to the present exemplary embodiment further includes a central processing unit (CPU), a read only memory (ROM), a random access memory (RAM), etc. and is provided with a controller that controls the operations of devices and units included in the image forming apparatus 100.

The image forming units 10 are an example of an image forming section.

The image forming apparatus 100 further includes: an intermediate transfer belt 20 on which single-color toner images formed by the image forming units 10 are sequentially transferred (first transfer) and the transferred single-color toner images are held; and a second-transfer device 30 that transfers all the single-color toner images together from the intermediate transfer belt 20 onto a rectangular recording medium P (second transfer). The recording medium P is a medium such as paper or film to be subjected to fixation.

The image forming units 10 are an example of an image forming unit, and the intermediate transfer belt 20 and the secondary transfer device 30 are an example of a transfer unit.

The image forming apparatus 100 further includes a sheet feeder 40 that feeds recording mediums P. Plural transport rollers 41 that transport a recording medium P positioned in a sheet transport path are disposed between the sheet feeder 40 and the second-transfer device 30.

In the present exemplary embodiment, a fixing device 50 that fixes the image having been secondarily transferred onto the recording material P by the secondary transfer device 30 onto the recording material P is provided. In addition, a transport device 42 that transports the recording medium P passing through the second-transfer device 30 to the fixing device 50 is provided between the second-transfer device 30 and the fixing device 50.

Each of the image forming units 10 that functions as part of the image forming section includes a rotatably attached photoconductor drum 11. A charging unit 12 that charges the photoconductor drum 11, an exposure unit 13 that exposes the photoconductor drum 11 to light to thereby write an electrostatic latent image onto the photoconductor drum 11, and a developing unit 14 that develops the electrostatic latent image on the photoreceptor drum 11 with a toner to obtain a visible image are disposed around the photoconductor drum 11. Moreover, a first-transfer unit 15 is provided which transfers a single-color toner image formed on the photoconductor drum 11 to the intermediate transfer belt 20, and a drum cleaning unit 16 is provided which removes the toner remaining on the photoconductor drum 11.

The intermediate transfer belt 20 is looped over plural roller members 21, 22, 23, 24, 25, and 26 and moves in a circulating manner. Among these roller members 21 to 26, the roller member 21 drives the intermediate transfer belt 20. The roller member 25 is disposed so as to be opposed to a second-transfer roller 31 with the intermediate transfer belt 20 therebetween, and the second-transfer roller 31 and the roller member 25 form the second-transfer device 30.

A belt cleaner 27 that removes toners remaining on the intermediate transfer belt 20 is disposed at a position opposed to the roller member 21 with the intermediate transfer belt 20 therebetween.

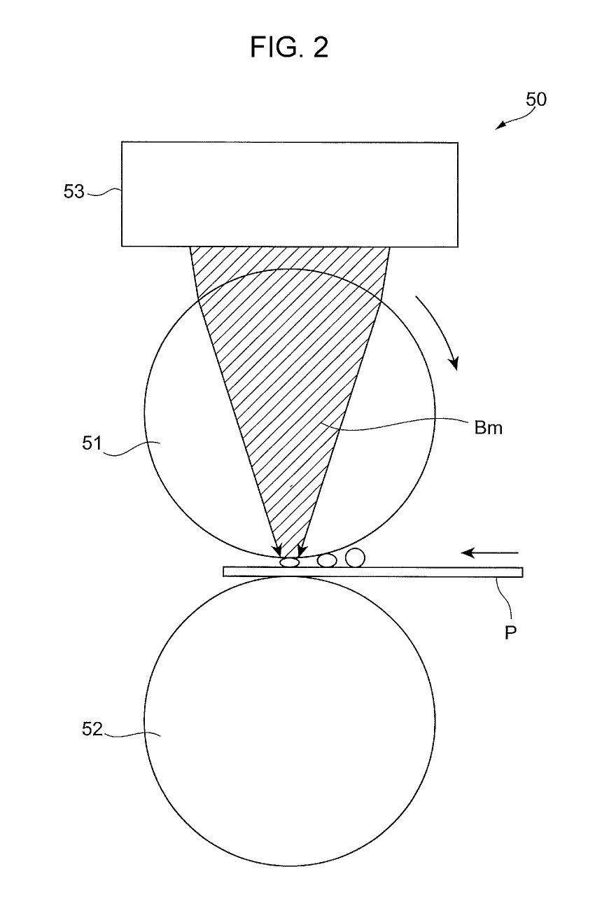

FIG. 2 is an illustration showing a schematic configuration of the fixing device 50.

As shown in FIG. 2, in the present exemplary embodiment, the fixing device 50 includes a rotatable transparent rod 51 and an opposed roller 52. The transparent rod 51 has a cylindrical shape and is formed of a transparent material that can transmit light beams Bm, and the opposed roller 52 is opposed to the transparent rod 51 with a contact region formed therebetween and co-operates with the transparent rod 51 to move and transport a recording medium P. The fixing device 50 further includes a light-concentrating device (linear light-concentrating device) 53 that projects, into the transparent rod 51, laser beams or light beams Bm that are to be concentrated on a liner region (with a small light concentrating width) extending over the entire width of a recording medium P on which images are transferred. The transparent rod 51 is an example of a columnar member and an example of a rotatable member, and the opposed roller 52 is an example of an opposed member. The light-concentrating device 53 is an example of a laser beam irradiation device.

The fixing device 50 is a laser fixing device that heats toners on a recording medium P directly with the light beams Bm emitted from the light-concentrating device 53 and concentrated on the linear region to thereby fuse and fix the toners. By reducing the width of the linear region, the efficiency of light concentration is improved, and the fixed portion is cooled rapidly.

The term “transparent” in the transparent rod 51 means that its transmittance in the wavelength range of the light beams Bm is high, and any transparent rod may be used so long as it transmits the light beams Bm. From the viewpoint of the efficiency of light utilization, the higher the transmittance, the better. The transmittance is, for example, 90% or more and preferably 95% or more.

The opposed roller 52 is formed of, for example, aluminum, stainless steel, or a copper sheet plated with nickel etc. and is disposed such that a predetermined pressing force acts between the opposed roller 52 and the transparent rod 51.

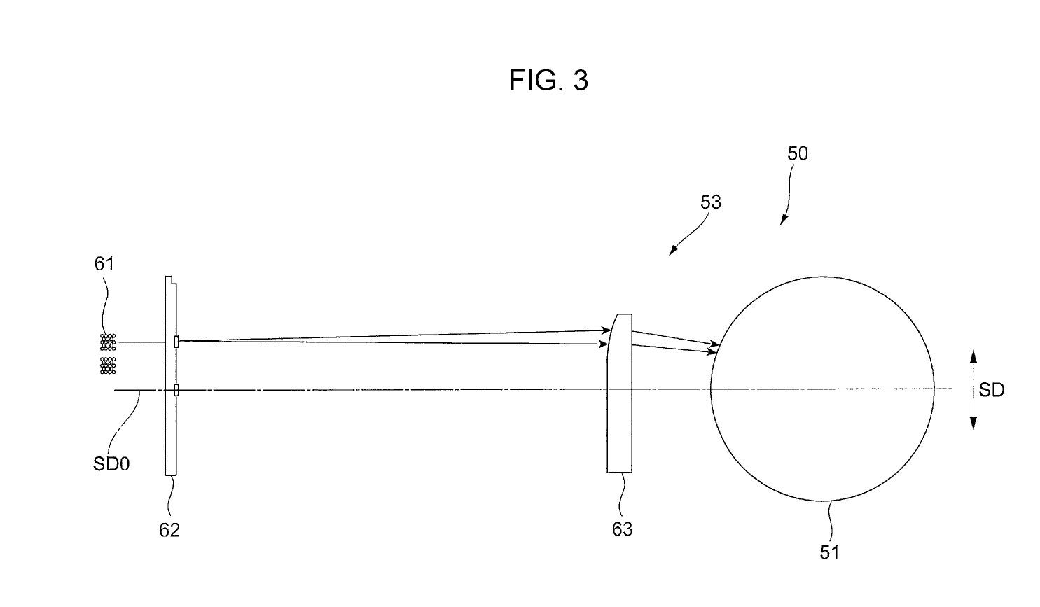

FIG. 3 is an illustration showing the light-concentrating device 53 of the fixing device 50.

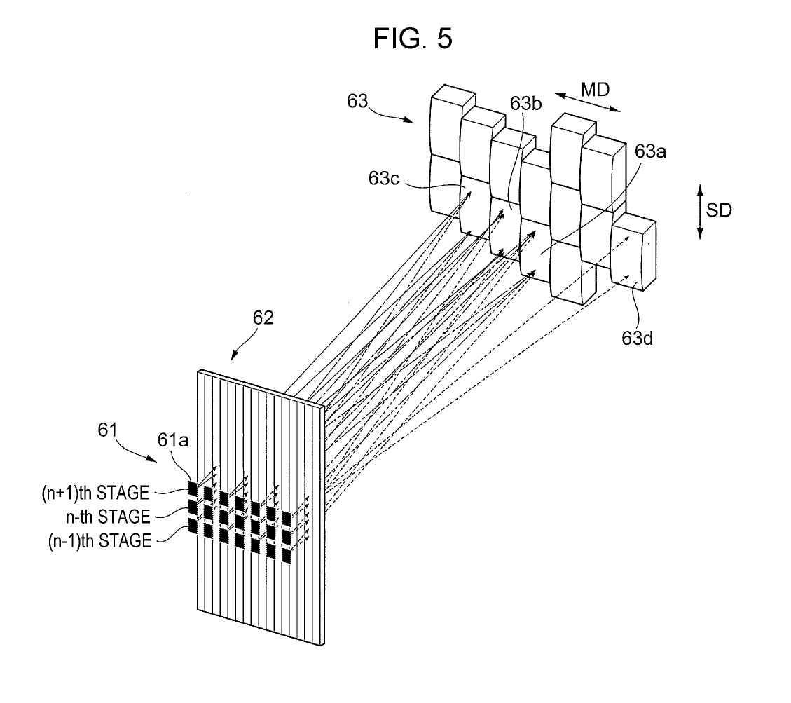

As shown in FIG. 3, the light-concentrating device 53 is configured to include: a surface-emitting laser unit 61 that is an example of a light-emitting body that emits the light beams Bm; and a first optical element group 62 that limits broadening of the light beams Bm emitted from the surface-emitting laser unit 61. Specifically, the first optical element group 62 limits the broadening of the light beams Bm in a main-direction MD, which is an example of a first direction. The light-concentrating device 53 further includes a second optical element group 63 that deflects the light beams Bm from the first optical element group 62 in a sub-direction SD, which is an example of a second direction (see, for example, FIG. 5), and is combined with the above-described transparent rod 51 to thereby concentrate the light beams Bm on the light exit side surface of the transparent rod 51. The sub-direction SD originates from a plane SDO (indicated by a dash-dot line in FIG. 3) that includes the central axis of the transparent rod 51 and a direction perpendicular to a light-emitting surface of the surface-emitting laser unit 61, and the distance from the plane SDO is used as an SD-direction height. Specifically, by decentering block cylinder elements in the second optical element group 63 as described later, a light-concentrating ability is imparted to a bundle optical system. The light-concentrating ability obtained by combining the second optical element group 63 with the transparent rod 51 disposed downstream thereof is controlled by the amount of decentering.

In one possible example of the bundle optical system, the second optical element group 63 may be an optical element that collimates the light beams Bm from the first optical element group 62 in the sub-direction SD, and a compensating cylinder may be disposed between the second optical element group 63 and the transparent rod 51. The compensating cylinder is an aspherical cylindrical lens that compensates for aberration characteristics of the transparent rod 51 when the light beams Bm are concentrated on the light-exit side surface of the transparent rod 51. However, in the present exemplary embodiment, the number of parts is smaller than that in the above example because the compensating cylinder is omitted.

In the light-concentrating device 53, the first optical element group 62 and the second optical element group 63 are disposed at different positions with respect to the emission direction of the surface-emitting laser unit 61. More specifically, the first optical element group 62 is disposed between the surface-emitting laser unit 61 and the second optical element group 63.

The main-direction MD is substantially the same as the lengthwise direction of the linear region, and the sub-direction SD is substantially the same as the transportation direction of a recording medium P (see FIG. 2).

The light-concentrating device 53 will be described further. The light-concentrating device 53 is configured such that the light beams Bm are concentrated on the light-exit side surface of the transparent rod 51 through the decentered block cylinder elements in the second optical element group 63 and the transparent rod 51. Therefore, in the present exemplary embodiment, the light-exit side surface of the transparent rod 51 is used for laser fixation.

In the present exemplary embodiment, the distance from the surface-emitting laser unit 61 to the incident surface of the first optical element group 62 is 9 mm, and the distance from the light-exit side surface of the first optical element group 62 to the incident surface of the second optical element group 63 is 76 mm. The distance between the light-exit side surface of the second optical element group 63 and the incident surface of the transparent rod 51 is 14 mm. The thickness of the first optical element group 62 is 2 mm, and the thickness of the second optical element group 63 is 5 mm. The diameter of the transparent rod 51 is 40 mm.

The components of the light-concentrating device 53 will next be described.

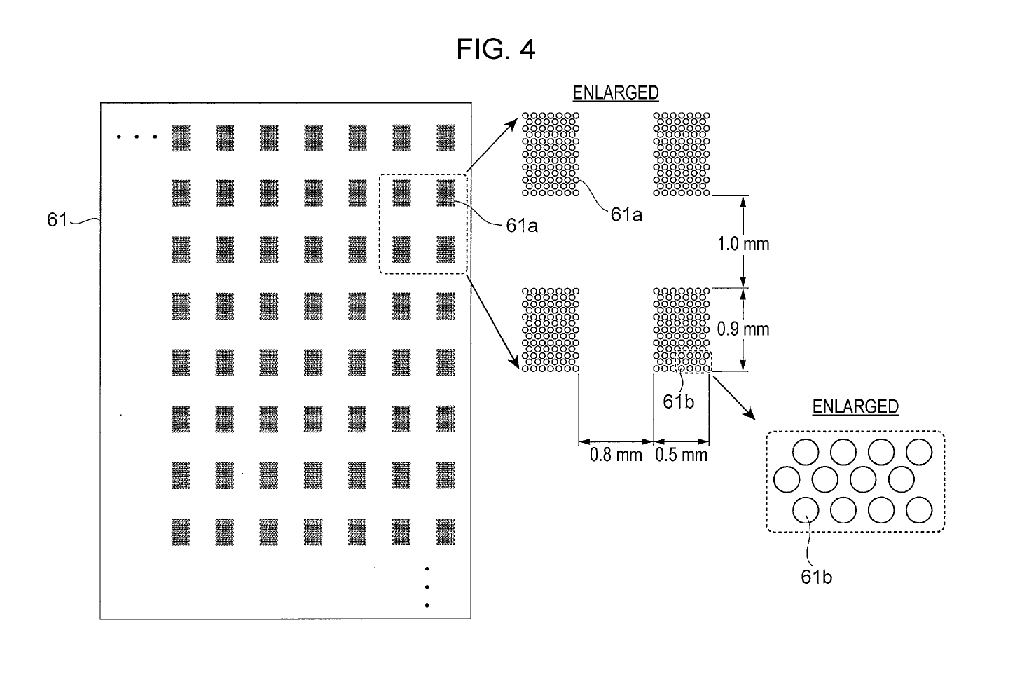

FIG. 4 is an illustration showing the surface-emitting laser unit 61.

As shown in FIG. 4, the surface-emitting laser unit 61 is a two-dimensional light-emitting element array, and light-emitting chips 61a, which are an example of light-emitting surfaces, are arranged two dimensionally or in two directions with gaps therebetween. In the present exemplary embodiment, the light-emitting chips 61a have an outer shape of 0.9 mm×0.5 mm. The vertical gap in FIG. 4 is 1.0 mm, and the horizontal gap is 0.8 mm. The center-to-center distance between adjacent chips in the vertical direction (sub-direction SD) is 1.9 mm, and the center-to-center distance between adjacent chips in the horizontal direction (main-direction MD) is 1.3 mm. In the present exemplary embodiment, 20 stages of chips are disposed in the vertical direction in FIG. 4.

Each of the light-emitting chips 61a is a collection of plural light-emitting elements or light-emitting points 61b and is configured by densely arranging the light-emitting points 61b. More specifically, light-emitting points 61b are two-dimensionally arranged to form each light-emitting chip 61a, and the light-emitting chips 61a are two-dimensionally arranged to form the surface-emitting laser unit 61.

These light-emitting chips 61a correspond one-to-one with sawtooth optical elements in the first optical element group 62 described later.

In the present exemplary embodiment, each light-emitting chip 61a is not a high-power edge emitting laser but is a vertical cavity surface emitting laser (VCSEL). Therefore, in the configuration used, the power of the chip is ensured by a large number of light-emitting points. Therefore, in the configuration used as an alternative to a power laser, light beams are concentrated on the linear region through the first optical element group 62 and the second optical element group 63 in such a manner that light concentration loss is reduced. The light beams from the surface-emitting laser unit 61 are concentrated such that their planar beam shape is converted to a line (linear) shape.

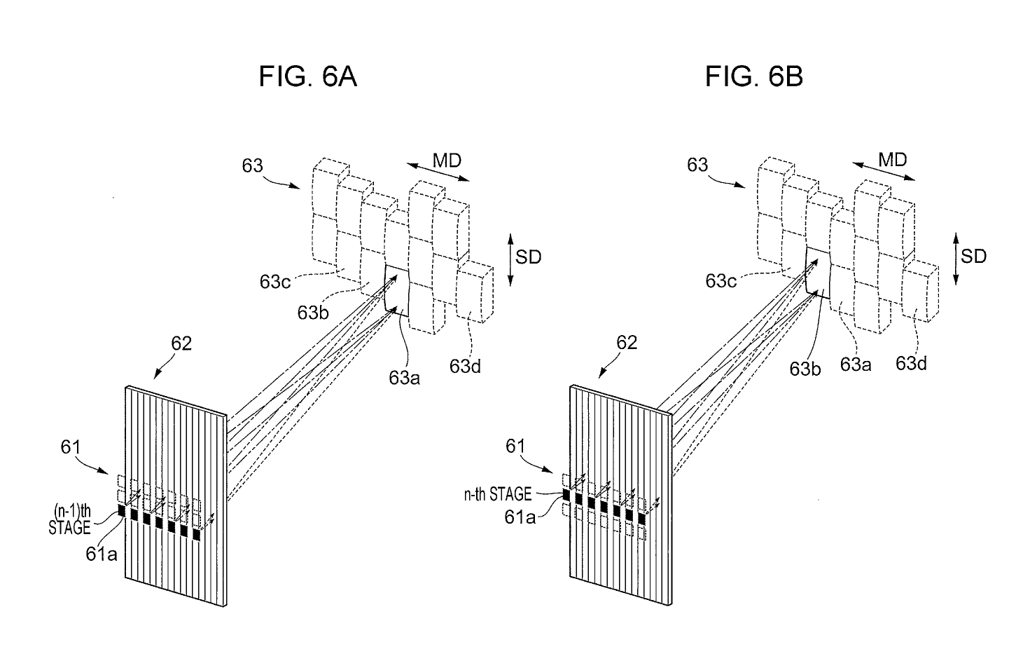

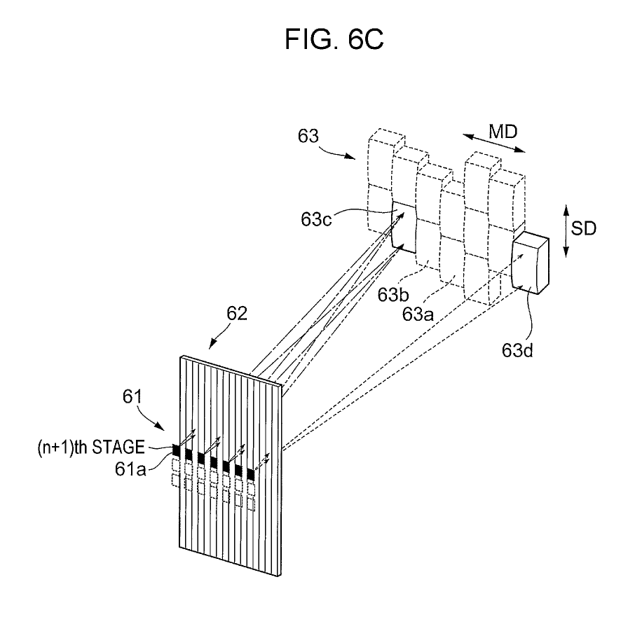

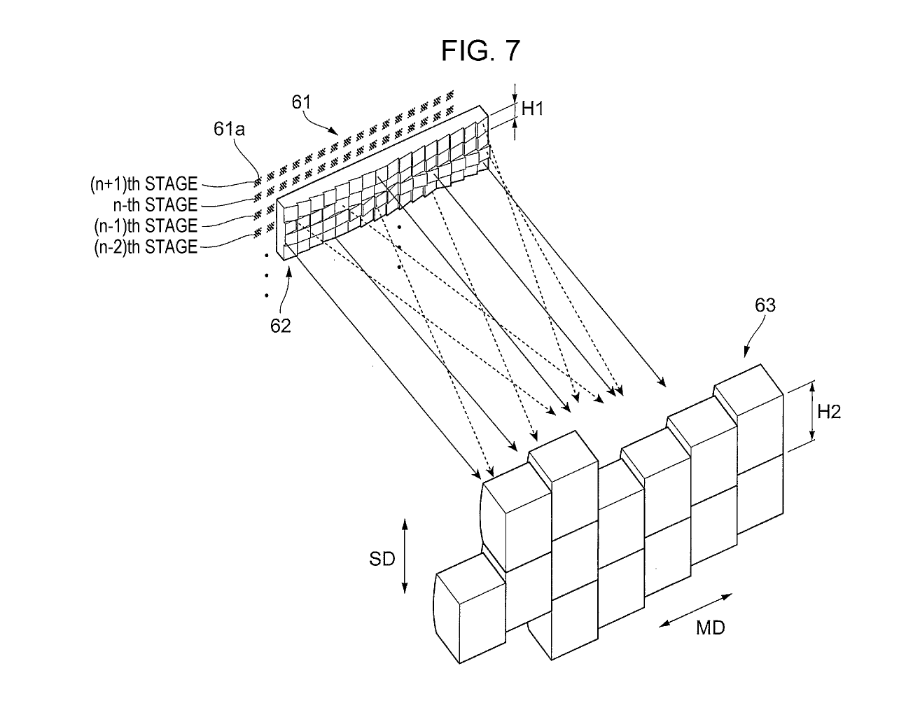

FIGS. 5, 6A, 6B, 6C, and 7 are perspective views showing the bundle optical system. FIGS. 5, 6A, 6B, and 6C are perspective views as viewed in an optical path direction, and FIG. 7 is a perspective view as viewed in a direction opposite to the optical path direction. FIGS. 6A, 6B, and 6C are schematic illustrations showing guidance of light beams from different stages in the bundle optical system shown in FIG. 5.

This bundle optical system is an optical system configured to avoid overlaps between adjacent light beams and includes the first optical element group 62 and the second optical element group 63. Specifically, in the bundle optical system, light beams are bundled in the main-direction MD through the first optical element group 62 and guided to their respective block cylinder elements in the second optical element group 63. In this case, light beams from different stages of light-emitting chips 61a of the surface-emitting laser unit 61 that are different with respect to the sub-direction SD are guided to different block cylinder elements shifted from each other in the main-direction MD and the sub-direction SD such that these light beams are guided to different positions and separated from each other. The overlaps between adjacent light beams are thereby avoided.

This will be described more specifically. In the bundle optical system shown in FIG. 5, the first optical element group 62 limits the spreading, in the main-direction MD, of light beams from light-emitting points 61b in the same stage and guides these light beams to an aperture of the second optical element group. The first optical element group 62 is divided in the main-direction MD and the sub-direction SD into blocks that form first optical elements. More specifically, the first optical element group 62 includes unit column cylinders on the incident side shown in FIGS. 5, 6A, 6B, and 6C and sawtooth optical elements on the light exit side shown in FIG. 7. The sawtooth optical elements are Fresnel lens-like sawtooth optical elements for deflection toward the block cylinder elements. A deflecting characteristic that causes an incident light beam from the surface-emitting laser unit 61 to be converted to an exit light beam deflected in the main-direction MD is achieved by these unit column cylinders and sawtooth optical elements. The sawtooth optical elements allow adjacent ones of the first optical elements that are adjacent in the sub-direction SD to have different deflecting characteristics in the main-direction MD. Therefore, light beams from different stages in the surface-emitting laser unit 61 are guided separately to the second optical element group 63. Arrows shown in FIGS. 5, 6A, 6B, and 6C are light beams from only representative light-emitting points for purposes of brevity. The spreading of the light beams in the sub-direction SD is not limited by the first optical elements, and the spreading in the vertical direction remains present as shown in these figures. The light beams spread in the sub-direction SD are converted to collimated light beams or converging light beams through the block cylinder elements in the second optical element group 63.

The second optical element group 63 is an array of block cylinder elements. The second optical element group 63 includes single second optical elements (block cylinder elements) separated in the main-direction MD as blocks or separated in the main-direction MD and the sub-direction SD as blocks.

These second optical elements are formed on at least one side, have optical power in the sub-direction SD, and convert the light beams emitted from their corresponding light-emitting chips 61a and diverging in the sub-direction SD to converging light beams. To achieve this function, the generating lines of the cylindrical surfaces of adjacent second optical elements have different heights in the sub-direction SD (these heights are hereinafter referred to as the “heights, in the second direction, of the optical axes of the second optical elements [block cylinder elements]” or simply as the “heights of the optical axes of the second optical elements [block cylinder elements]”). Specifically, the heights of the optical axes of adjacent second optical elements differ by the difference in SD-direction height between light-emitting chips 61a corresponding to these second optical elements plus their amount of decentering (described later). When the second optical elements are formed on one side, their manufacturing cost is lower than that when the second optical elements are formed on both sides, and more gentle optical conditions are obtained. However, when the second optical elements are formed on both sides, their curves are more gentle than those when the second optical elements are formed on one side.

As shown in FIG. 5, the unit column cylinders in the first optical element group 62 are formed so as to extend in the sub-direction SD, and each unit column cylinder limits the broadening, in the main-direction MD, of light beams from light-emitting points in a corresponding column in the surface-emitting laser unit 61.

As shown in FIGS. 5 to 7, the sawtooth optical elements in the first optical element group 62 bundle light beams from the same groups of light-emitting chips 61a (i.e., from the same stages) at the same positions (the same height positions) in the sub-direction SD (to form bundles of light beams) such that the light beams from light-emitting chips 61a adjacent in the sub-direction SD do not overlap. The bundles of light beams are directed toward their corresponding apertures 63a, 63b, 63c, and 63d of the second optical element group 63. Specifically, the light beams from light-emitting chips 61a in the (n−1)th stage, n-th stage, and (n+1)th stage arranged at different positions with respect to the sub-direction SD are guided to different apertures, with respect to the main-direction MD, of the second optical element group 63 through the first optical element group 62.

In particular, FIG. 6A shows guidance of light beams from light-emitting chips 61a in the (n−1)th stage in the surface-emitting laser unit 61 including the light-emitting chips 61a arranged two-dimensionally. FIG. 6B shows guidance of light beams from light-emitting chips 61a in the n-th stage, and FIG. 6C shows guidance of light beams from light-emitting chips 61a in the (n+1)th stage.

Specifically, the light beams from the light-emitting chips 61a in the (n−1)th stage are guided to the aperture 63a of the second optical element group 63 through sawtooth optical elements in the first optical element group 62 as shown in FIG. 6A. As shown in FIG. 6B, the light beams from the light-emitting chips 61a in the n-th stage are guided to the aperture 63b of the second optical element group 63. As shown in FIG. 6C, light beams from light-emitting chips 61a in the (n+1)th stage are guided to the aperture 63c of the second optical element group 63. As described above, light beams from different groups of light-emitting chips 61a that are different with respect to the sub-direction SD are guided to their corresponding different block cylinder elements.

In FIG. 6C, the light beams from the light-emitting chips 61a in the (n+1)th stage are guided to the aperture 63c or on the aperture 63d different from the aperture 63c, and this depends on the positions of the light-emitting chips 61a in the main-direction MD.

In the surface-emitting laser unit 61, all the light-emitting chips 61a emit light simultaneously. However, in another exemplary embodiment, only part of the light-emitting chips 61a may emit light.

A description will be given of the relation between the length, in the sub-direction SD, of the first optical elements in the first optical element group 62 and the length, in the sub-direction SD, of the second optical elements in the second optical element group 63. As shown in FIG. 7, the length H2, in the sub-direction SD, of the second optical elements is larger than the length H1, in the sub-direction SD, of the first optical elements. In other words, the length, in the sub-direction SD, of the unit optical element of the second optical element group 63 is larger than the length, in the sub-direction SD, of the unit optical element of the first optical element group 62. To ensure image forming magnification, it is necessary that the second optical element group 63 be disposed downstream of the first optical element group 62 in the direction of the emission optical axes of the light emitting elements. The spreading of the exit beams in the sub-direction SD is larger at the emission optical axis direction position of the second optical element group 63 than the emission optical axis direction position of the first optical element group 62. Therefore, when the length H2 is larger than the length H1, the efficiency of light concentration is higher than that in a different configuration.

The sawtooth optical elements in the first optical element group 62 will be described in more detail.

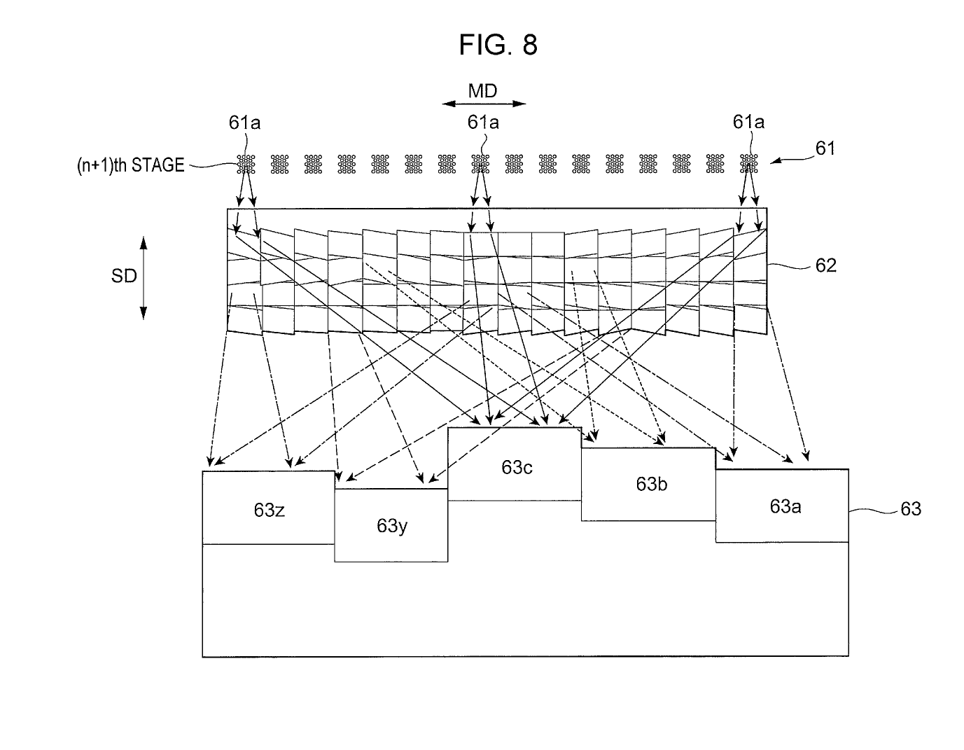

FIG. 8 is an illustration showing the sawtooth optical elements in the first optical element group 62. FIG. 8 is a schematic diagram as viewed downward in the same direction as that in FIG. 7, i.e., the direction opposite to the optical path direction, and shows the sawtooth optical elements in more detail. In FIG. 8, the light-emitting chips 61a in the (n+1)th stage in the surface-emitting laser unit 61 are shown. Diverging light beams from light-emitting points 61b in central portions of light-emitting chips 61a (central light-emitting points) are indicated by solid lines. Light beams from the n-th stage are indicated by dotted lines (short dashed lines). Light beams from the (n−1)th stage are indicated by dash-dot lines, and light beams from the (n−2)th stage are indicated by broken lines (long dashed lines).

As shown in FIG. 8, the diverging characteristics of the diverging light beams from the central light-emitting points are reduced in the main-direction MD by the unit column cylinders on a first surface (the incident-side surface) of the first optical element group 62, and the resulting light beams are deflected and guided (bundled) toward their corresponding block cylinder elements in the second optical element group 63 by the sawtooth optical elements on a second surface (the emitting surface) of the first optical element group 62.

In the first optical element group 62, when plural first optical elements continuously arranged in the main direction MD at the same position in the sub-direction SD (in the same stage) are in the same group, they correspond to the same block cylinder element. When these first optical elements are in different groups, they correspond to different block cylinder elements. Specifically, first optical elements continuously arranged in the main direction MD at the same position in the sub-direction SD (in the same stage) and in the same group correspond to the same block cylinder element. Light beams from first optical elements that are in the same stage but are in different groups are deflected and guided to different block cylinder elements separated by one period.

In other words, plural first optical elements continuously arranged in the main-direction MD are grouped (into a constituent unit). These first optical elements have such deflecting characteristics in the main-direction MD that light beams emitted from these first optical elements in the same group are deflected toward the aperture of their corresponding second optical element. Specifically, plural first optical elements continuously arranged in the main-direction MD are grouped into a single constituent unit, and light beams emitted from this constituent unit are deflected and guided to the same block cylinder element. Different constituent units correspond to different block cylinder elements.

More specifically, as shown in FIG. 8, the divergence characteristics of the diverging light beams from light-emitting chips 61a in, for example, the (n+1)th stage in the surface-emitting laser unit 61 are reduced in the main-direction MD by the unit column cylinders on the incident side of the first optical element group 62. The resulting light beams are deflected and guided by the sawtooth optical elements on the emission side toward their corresponding block cylinder element in the second optical element group 63.

As descried above, the unit column cylinders in the first optical element group 62 have characteristics that cause the incident light beams to be converted to exit light beams with their diverging characteristics reduced in the main-direction MD. Adjacent sawtooth optical elements in the first optical element group 62 have different deflecting characteristics with respect to the main direction.

Specifically, light beams from first optical elements in the same group in the same stage are deflected and guided to the same block cylinder element. As shown in FIG. 8, for example, light beams from the same group in the (n+1)th stage are guided to the aperture 63c of the second optical element group 63 (see solid lines), and light beams from the same group in the n-th stage are guided to the aperture 63b (see broken lines). Light beams from a first group in the (n−1)th stage are guided to the aperture 63a, and light beams from a second group in the (n−1)th stage are guided to another aperture 63z. Light beams from the same group in the (n−2)th stage are guided to an aperture 63y.

As described above, light beams from different groups in the same stage are deflected and guided to different block cylinder elements. These light beams from different groups are deflected and guided to different block cylinder elements separated by one period. In FIG. 8, only representative light beams from each of the groups are shown for purposes of brevity.

Next, the correspondence between bundles of light beams and the block cylinder elements in the second optical element group 63 will be described. Specifically, a description will be given of the correspondence between bundles of light beams and the block cylinder elements in the second optical element group 63 when the light beams from the surface-emitting laser unit 61 are deflected in the main-direction MD by the first optical element group 62 and guided to the block cylinder elements in the second optical element group 63.

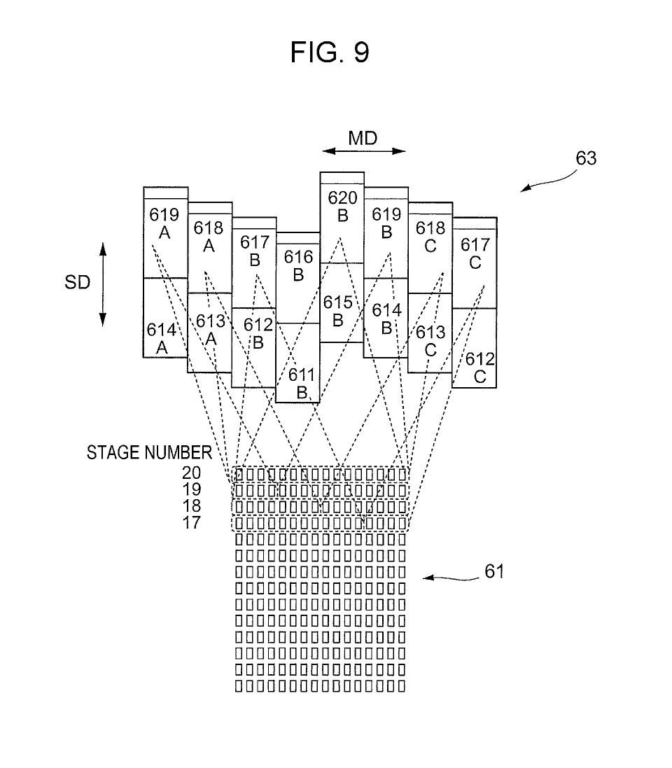

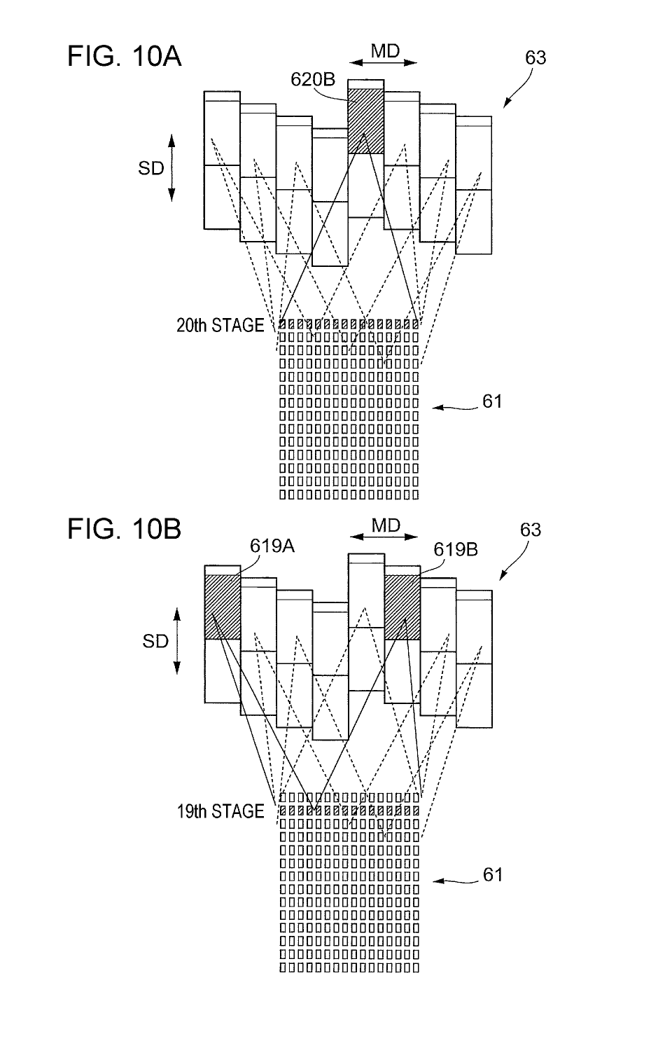

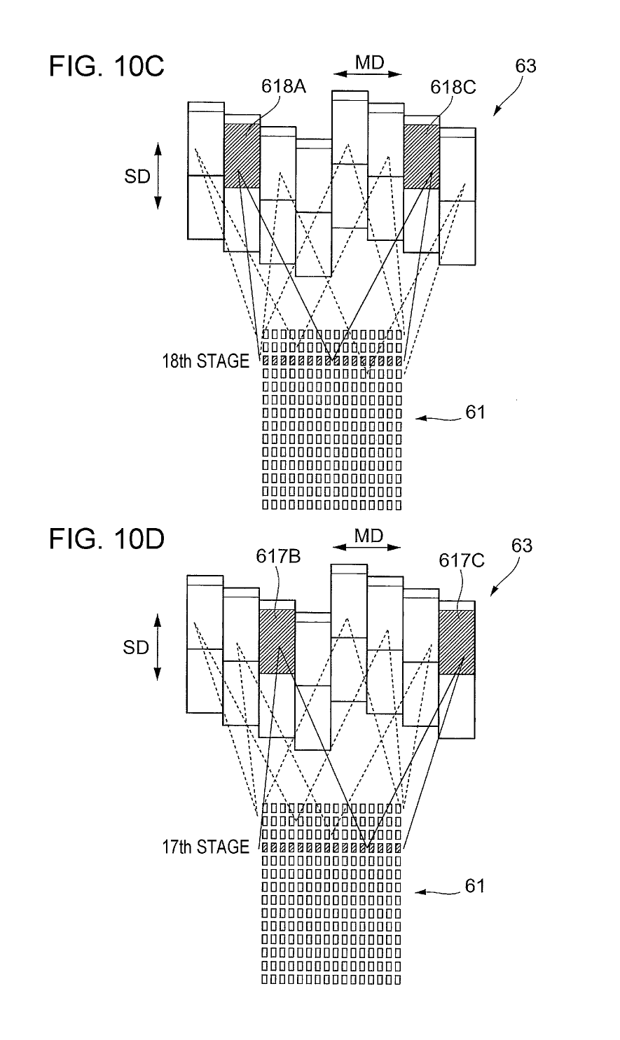

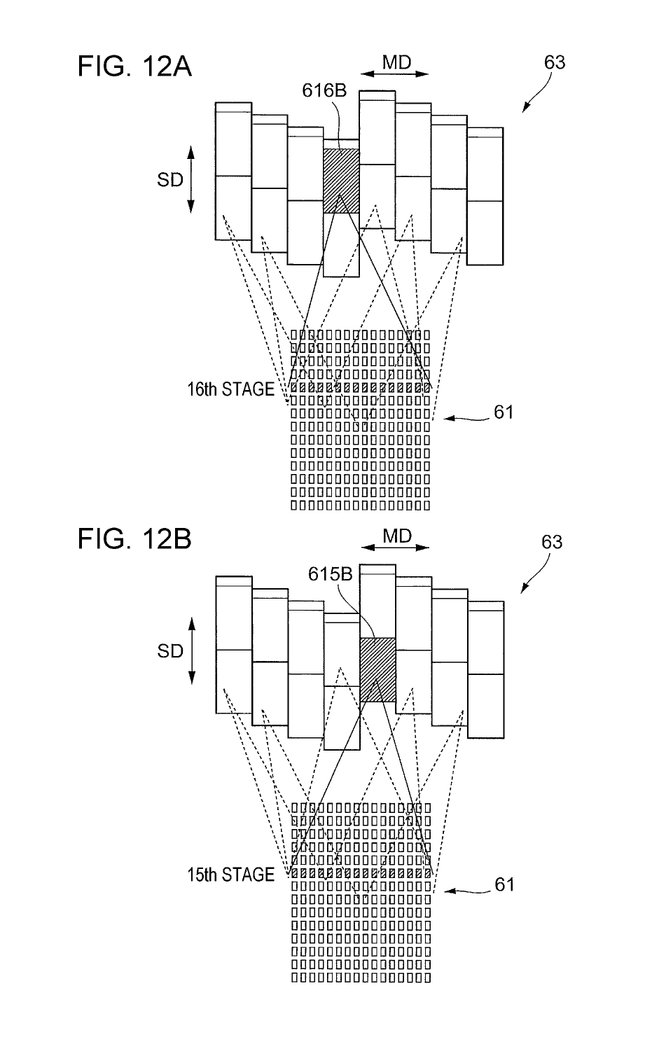

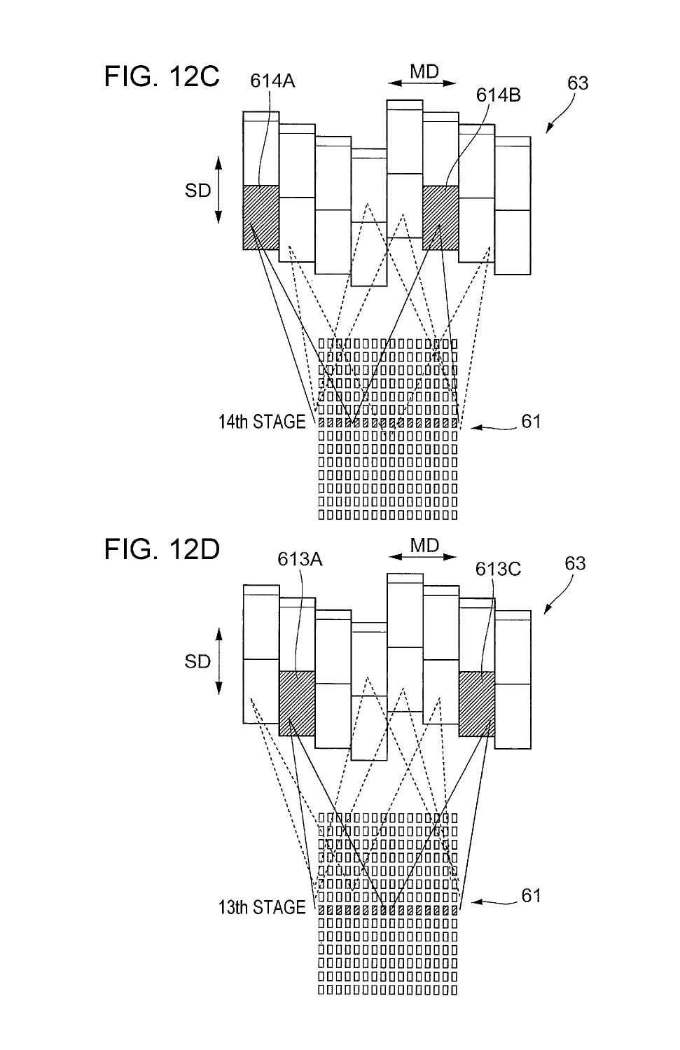

FIGS. 9, 10A, 10B, 10C, 10D, 11, 12A, 12B, 12C, and 12D are illustrations showing the correspondence between bundles of light beams and the block cylinder elements in the second optical element group 63. In these figures, the surface-emitting laser unit 61 includes light-emitting chips 61a that are arranged horizontally and vertically in an array with 20 stages. The second optical element group 63 shown is divided into 5 stages in the sub-direction SD. FIGS. 10A, 10B, 10C, and 10D may be collectively referred to as “FIGS. 10,” and FIGS. 12A, 12B, 12C, and 12D may be collectively referred to as “FIGS. 12.”

More specifically, FIG. 9 illustrates block cylinder elements corresponding to deflection of light beams from upper four stages (the 20th stage to the 17th stage). FIG. 10A is a close-up of the correspondence in the 20th stage, and FIG. 10B is a close-up of the correspondence in the 19th stage. FIG. 10C is a close-up of the correspondence in the 18th stage, and FIG. 10D is a close-up of the correspondence in the 17th stage.

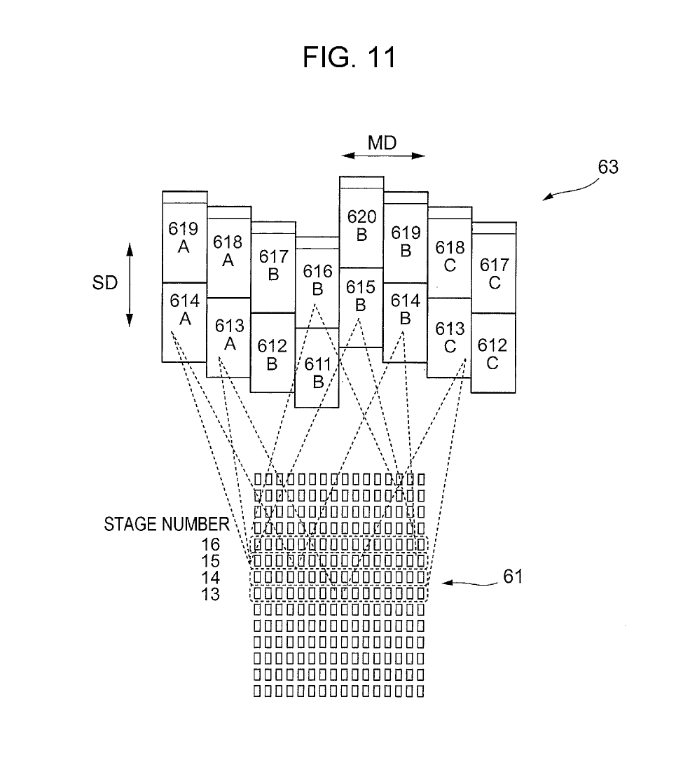

FIG. 11 illustrates block cylinder elements corresponding to deflection of light beams from next four stages (the 16th stage to the 13th stage). FIGS. 12A, 12B, 12C, and 12D are close-ups of the correspondences in the 16th stage, the 15th stage, the 14th stage, and the 13th stage, respectively.

In the surface-emitting laser unit 61, all the light-emitting chips 61a emit light simultaneously. However, in another exemplary embodiment, only part of the light-emitting chips 61a may emit light.

As particularly shown in FIG. 9 or 11, the light beams from the 20 stages are deflected such that the light guidance position of a bundle of light beams from one stage is shifted diagonally downward from that of a bundle of light beams from a stage above the one stage. Therefore, the block cylinder elements (hereinafter abbreviated as “elements”) 620B etc. of the second optical element group 63 are arranged so as to be shifted in the main-direction MD and the sub-direction SD. An element 619B adjacent to the element 620B in the main-direction MD is shifted in the sub-direction SD. Similarly, elements 618C, 617C, and 616C are sequentially shifted in the sub-direction SD.

An element 615B is adjacent to the element 620B in the sub-direction SD, and an element 614B adjacent to the element 615B in the main-direction MD is shifted relative to the element 615B in the sub-direction SD. Also elements 613C, 612C, and 611C are shifted in the sub-direction SD.

In FIGS. 9 to 12, only a part of the surface-emitting laser unit 61 is shown, and the rest of the surface-emitting laser unit 61 in the main-direction MD and the sub-direction SD is omitted.

The correspondence between the bundles of light beams and the block cylinder elements will be described more specifically.

In FIG. 10A that focuses on the 20th stage in the surface-emitting laser unit 61, a bundle of 16 light beams is deflected toward the element 620B. In FIG. 10B that focuses on the 19th stage, a bundle of 4 light beams is deflected toward an element 619A, and a bundle of 12 light beams is deflected toward the element 619B. In FIG. 10C that focuses on the 18th stage, a bundle of 8 light beams is deflected toward an element 618A, and a bundle of 8 light beams is deflected toward the element 618C. In FIG. 10D that focuses on the 17th stage, a bundle of 12 light beams is deflected toward an element 617B, and a bundle of 4 light beams is deflected toward the element 617C.

The description will be continued. In FIG. 12A that focuses on the 16th stage, a bundle of 16 light beams is deflected toward an element 616B. In FIG. 12B that focuses on the 15th stage, a bundle of 16 light beams is deflected toward the element 615B. In FIG. 12C that focuses on the 14th stage, a bundle of 4 light beams is deflected toward an element 614A, and a bundle of 12 light beams is deflected toward the element 614B. In FIG. 12D that focuses on the 13th stage, a bundle of 8 light beams is deflected toward an element 613A, and a bundle of 8 light beams is deflected toward the element 613C.

As described above, the bundles of light beams from the stages in the surface-emitting laser unit 61 are deflected by the first optical element group 62 toward their corresponding block cylinder elements in the second optical element group 63.

Next, the curvature (the radius of curvature) of the unit column cylinders that limit the beam broadening in the main-direction MD in the first optical element group 62 will be described.

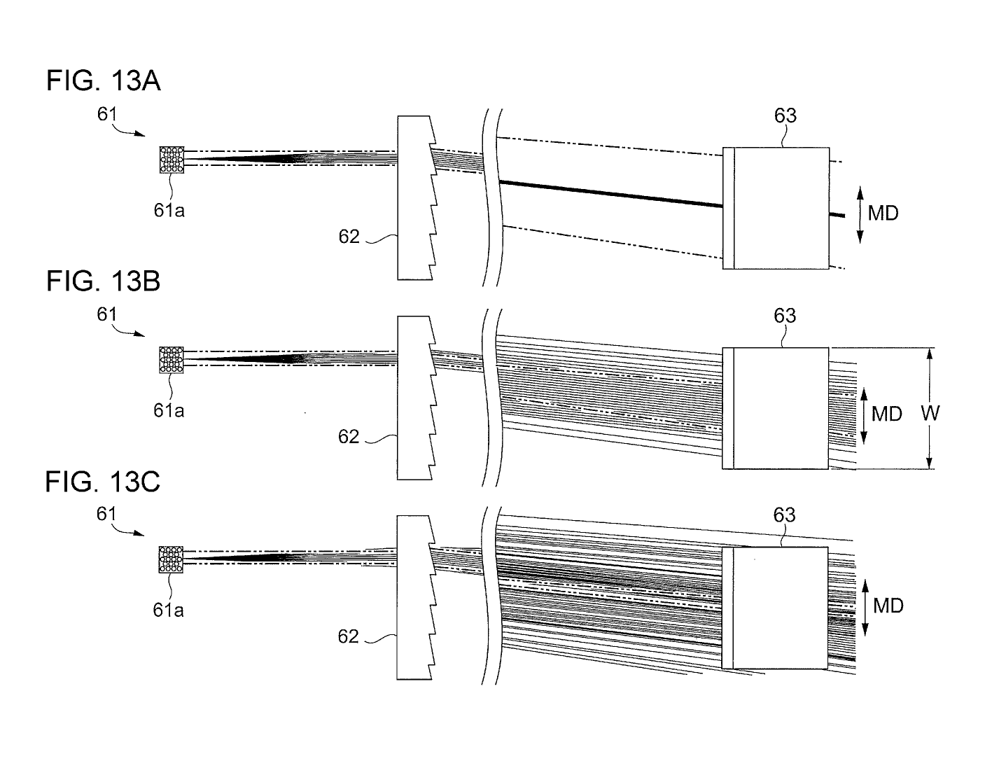

FIGS. 13A to 13C are illustrations showing the curvatures of unit column cylinders. The radii of curvature in FIGS. 13A to 13C are different from each other.

When the curvature is large (r=4 mm) as shown in FIG. 13A, the broadening, in the main-direction MD, of central light beams from a light-emitting chip of the surface-emitting laser unit 61 is reduced by a unit column cylinder in the second optical element group 63. However, light beams from the left and right edges of the light-emitting chip 61a (indicated by dash-dot-dot lines) are strongly refracted by the unit column cylinder as described later and are incident on the very edges of the aperture of the block cylinder element in the second optical element group 63. Therefore, if misalignment occurs, the light beams do not fit the aperture, and this causes light concentration loss.

When the curvature is small (r=20 mm) as shown in FIG. 13C, the light beams from the left and right edges are incident on the central portion of the aperture, but the light beams as a whole are broadened. In this case, robustness to misalignment is higher than that in FIG. 13A, but the efficiency of light concentration becomes low.

When the curvature (optical power) of the unit column cylinder is large (high) and the light beams from the central light-emitting points are focused at the position of the block cylinder element in the second optical element group 63 as shown in FIG. 13A, the axial light beams from left and right circumferential light-emitting points are strongly refracted, intersect at a point far forward of the block cylinder element, and are incident near the circumference of the block cylinder element. When the light-emitting chips 61a in the surface-emitting laser unit 61 are misaligned, the light beams may be deviated. Therefore, the surface-emitting laser unit 61 is excessively sensitive to misalignment.

In contrast, when the axial light beams from the left and right circumferential light-emitting points intersect at the position of the block cylinder element as shown in FIG. 13C, the converging power for the diverging light beams from the central light-emitting points is insufficient, and the incident efficiency becomes low.

In the case of FIG. 13B, the curvature is between the curvature in FIG. 13A and the curvature in FIG. 13C, i.e., r=6 to 9 mm. When the value of the curvature in FIG. 13B is used, susceptibility to misalignment is low. However, to ensure the efficiency of light concentration, it is necessary that the width w of the aperture of the block cylinder element be equal to the width of about four chips (about 5 mm). In other words, when the aperture width w is equal to the width of about 4 chips, the light beams from the left and right edges of the chip are incident on a relatively small area, and the efficiency of light concentration is ensured.

As described above, the curvature of the unit column cylinder is milder than the curvature that causes the light beams (solid lines) from the central light-emitting points of the light-emitting chip 61a to be focused at the position of the second optical element group 63 and is sharper than the curvature that causes the axial light beams (dash-dot-dot lines) from the left and right circumferential light-emitting points to be guided at the position of the second optical element group 63.

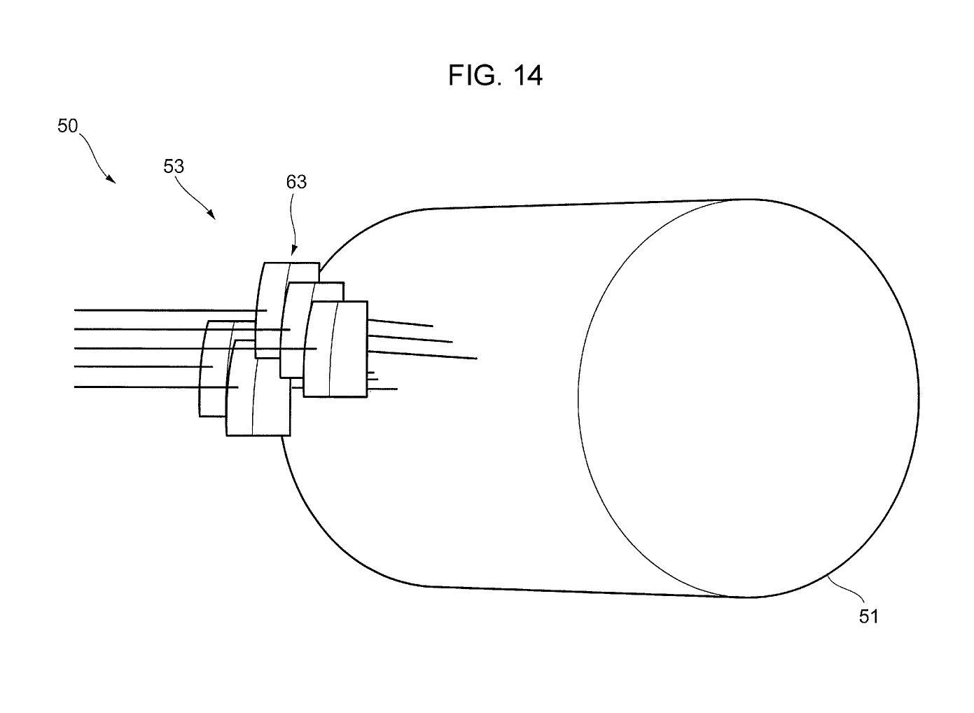

FIG. 14 is a schematic perspective view illustrating the decentering of the block cylinder elements in the second optical element group 63 and shows the block cylinder elements in the second optical element group 63 and the transparent rod 51 located rearward thereof.

When the diverging light beams from the light-emitting chips 61a of the surface-emitting laser unit 61 are converted to collimated light beams, the heights of the optical axes of the block cylinder elements are set to be equal to the SD-direction heights of the centers of their corresponding light-emitting chips 61a. In this case, the light beams emitted from the centers of the light-emitting chips 61a in the normal direction are not refracted by the block cylinder surfaces.

When the heights of the optical axes of the block cylinder elements are different (decentered) from the SD-direction heights of the centers of their corresponding light-emitting chips 61a as shown in FIG. 14, the light beams emitted from the centers of the light-emitting chips 61a in the normal direction are refracted by the block cylinder elements. The amount of refraction in this case may be controlled by the amount of decentering (the difference between the height of the optical axis of a block cylinder element and the SD-direction height of the centers of its corresponding light-emitting chips 61a). When the absolute value of the height of the optical axis of a block cylinder element is smaller than the absolute value of the SD-direction height of the centers of its corresponding light-emitting chips 61a, the position of the optical axis of the block cylinder moves in the direction getting closer to the SDO plane (including the central axis of the transparent rod 51), and the light beam parallel to the SDO plane is converted to a converging light beam toward the transparent rod 51.

In the block cylinder elements in the present exemplary embodiment, their curvature is sharper than the curvature condition that causes the light beams to be collimated by the second optical element group 63.

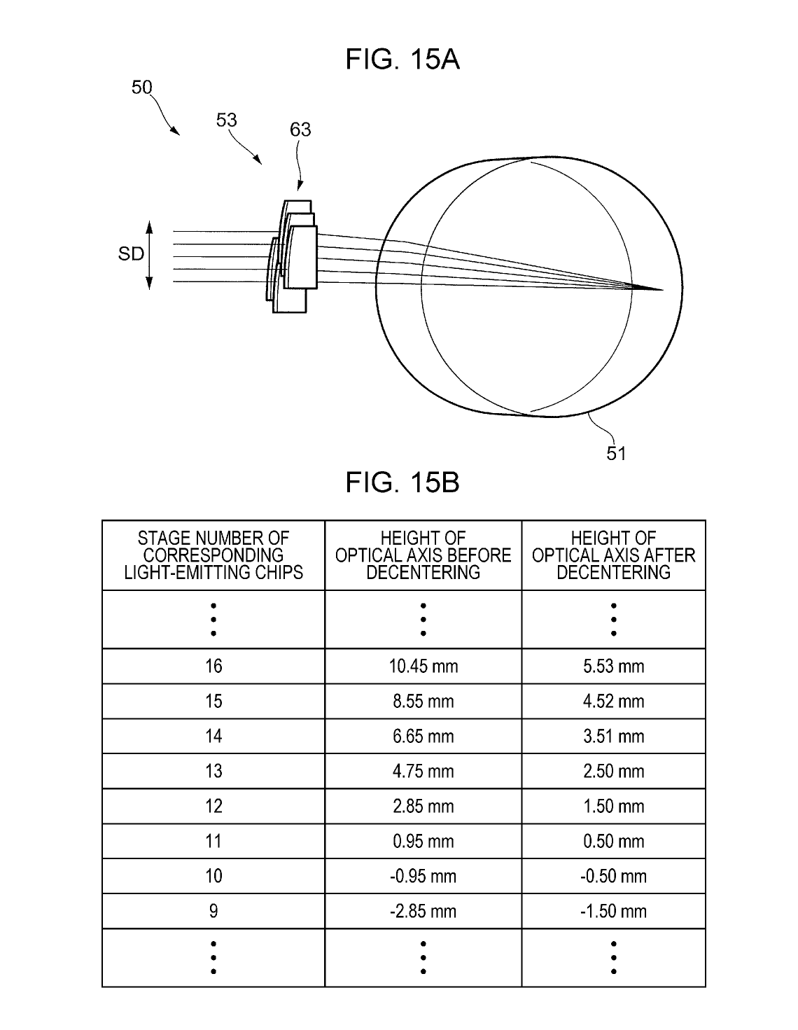

FIG. 15A is a schematic perspective view illustrating light concentration on the transparent rod 51 through the decentered block cylinder elements in the second optical element group 63, and FIG. 15B is a table showing the comparison between before and after decentering the sub-direction SD positions of the optical axes of block cylinder elements.

As shown in FIG. 15A, the converging light beams traveling inside the transparent rod 51 are concentrated on the light-exit side surface of the transparent rod 51. Specifically, by decentering the block cylinder elements in the second optical element group 63 relative to the light beams from the centers of the first optical elements in the first optical element group 62, the light beams can be concentrated on the linear region with the aid of the light concentrating power of the transparent rod 51.

In the first optical element group 62, the interval of the unit column cylinders in the main-direction MD is 1.3 mm, and their radius of curvature is 6 mm. The interval of the sawtooth optical elements in the sub-direction SD is 1.9 mm. In the second optical element group 63, when the radius of curvature is 22.6 mm and the conic constant is −1.2, the sub-direction SD positions (height positions) of the optical axes of the before-decentered and after-decentered block cylinder elements are, for example, as shown in FIG. 15B. By controlling the amount of decentering as described above, the aberration of the transparent rod 51 is also corrected.

Next, correction of skew aberration will be described. The skew aberration is a phenomenon in which a light beam incident on a block cylinder element at a non-zero incident angle in the main direction MD (an obliquely incident light component) is concentrated with a shift in the sub-direction SD because of the characteristics of the transparent rod 51. In a position at a light beam height of about 10 mm, the shift of the light concentration positon in the sub-direction SD due to skew aberration is about 0.05 mm at an incident angle of 6° and is about 0.06 mm, 0.09 mm, and 0.1 mm at incident angles of 7°, 8°, and 9°, respectively. When the surface-emitting laser unit 61 has a large outer shape, e.g., has 20 stages, the incident angle is large at a position far from the optical axis of the whole optical system, and the shift of the light concentration position increases accordingly.

Such a shift of the light concentration position is not negligible with respect to, for example, a target light concentration width of 0.3 mm. When the size of the surface-emitting laser unit 61 is as large as the diameter of the transparent rod 51, i.e., the light beam height is about 20 mm, the shift becomes larger. In the present exemplary embodiment, it is necessary to correct the skew aberration because of the above circumstances.

More specifically, the correction of skew aberration may be performed when the shift of the light concentration position in the sub-direction SD exceeds, for example, 0.08 mm. In this case, the correction of skew aberration is performed in a position that causes an incident angle of 8° to 9°. Even when the shift of the light concentration position is small, e.g., less than 0.08 mm, the correction of skew aberration may be performed in a position that causes a non-negligible shift of the light concentration position due to skew aberration, and this depends on the accuracy of light concentration.

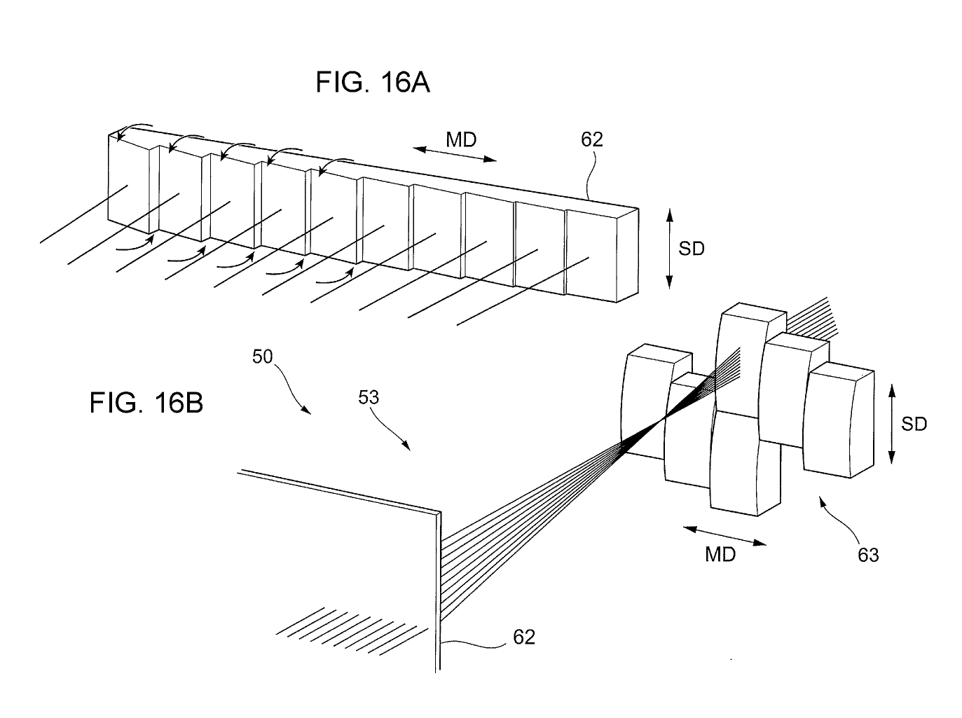

FIG. 16A is a perspective view of sawtooth optical elements in the first optical element group 62, showing the correction of skew aberration, and FIG. 16B is a perspective view of the first optical element group 62 and the second optical element group 63.

As described above, surfaces of the sawtooth optical elements in the first optical element group 62 are inclined with respect to the main-direction MD, so that the sawtooth optical elements deflect light beams in the main-direction MD and bundle the light beams. In addition, the surfaces of the sawtooth optical elements are inclined with respect to the sub-direction SD (i.e. the surfaces are rotated about an axis extending in the main-direction MD) as shown in FIG. 16A, so that the sawtooth optical elements deflect light beams in the sub-direction SD and reduce skew aberration. In this manner, as shown in FIG. 16B, the light concentration positions of the light beams are corrected by means of shifting their incident positions and incident angles in the sub-direction on the incident apertures of the block cylinder elements through deflecting the light beams exit from the first optical elements in the sub-direction SD.

As described above, the deflection by the sawtooth optical elements in the sub-direction SD causes the incident angles on the second optical element group 63 to be shifted in the sub-direction SD and causes the incident positions to be changed relative to the decentered positions, and the shifts of the light concentration positions in the sub-direction SD due to skew aberration are thereby corrected.

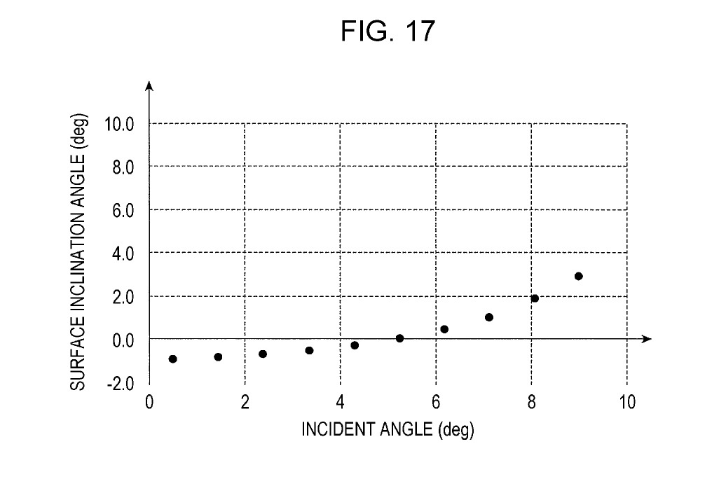

FIG. 17 is a graph showing the correction of skew aberration. The vertical axis represents a surface inclination angle (deg) of a first optical element with respect to a sub-direction SD, and the horizontal axis represents the incident angle (deg) in the main direction on a block cylinder element.

In the case shown in FIG. 17, the sign of the angle (the surface inclination angle (deg) of a first optical element with respect to a sub-direction SD) at the central position in the main direction MD is opposite to the sign of the angle at edge positions in the main direction MD. In this manner, skew aberration is corrected without increasing the surface inclination angle at the edge positions.

The skew aberration may be corrected without using the deflection in opposite sign directions.

The above optical system in which the light beams from the surface-emitting laser unit 61 are concentrated on the linear region is applied to the light-concentrating device 53 of the fixing device 50. In addition, the above optical system may be applied to a linear light-concentrating device used for laser processing etc.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A linear light-concentrating device comprising:
a light-emitting body that has a plurality of light-emitting surfaces arranged in two directions;
a first optical element group;
a second optical element group having a plurality of apertures, the first optical element group and the second optical element group being disposed at different positions with respect to an emission direction of the light-emitting body; and
a light-transmitting columnar member that has an optical axis, is disposed on an exit side of the second optical element group, and extends in a first direction,
wherein the first optical element group is divided in the first direction and a second direction different from the first direction into a plurality of first optical elements, each of the first optical elements has a deflecting characteristic that causes an incident light beam from the light-emitting body to be converted to an exit light beam deflected in the first direction, and adjacent ones of the first optical elements that are adjacent in the second direction have different deflecting characteristics in the first direction,
wherein at least one side of the second optical element group is divided at least in the first direction into a plurality of second optical elements each having an optical axis and having optical power in the second direction, and the optical axes of adjacent ones of the second optical elements have different heights in the second direction,
wherein the first optical elements include a plurality of constituent units each including at least two of the first optical elements that are continuous in the first direction, and the deflecting characteristics of the first optical elements are such that a group of exit light beams from each of the constituent units is deflected toward a corresponding one of the apertures of the second optical element group,
wherein the length of the second optical elements in the second direction is larger than the length of the first optical elements in the second direction,
wherein the optical axis of each of the second optical elements is decentered in the second direction from a central positon, with respect to the second direction, of a corresponding one of the first optical elements, and
wherein the optical axes of the second optical elements are decentered toward the optical axis of the columnar member.

2. The linear light-concentrating device according to claim 1,
wherein each of the first optical elements has a deflecting characteristic in the second direction, and
the deflecting characteristic of the each of the first optical elements in the second direction varies according to the distance from an optical axis of a whole optical system to an optical axis of the each of the first optical elements and the amount of deflection by the each of the first optical elements in the first direction.

3. A fixing device that fixes an image held on a recording medium, the fixing device comprising:
a rotatable member that has an optical axis and allows a laser beam to pass therethrough;
an opposed member that is opposed to the rotatable member with a contact region formed between the opposed member and the rotatable member and co-operates with the rotatable member in the contact region to move and transport the recording medium; and
a laser beam irradiation device that is disposed outside the rotatable member and irradiates a predetermined position of the rotatable member with a laser beam,
wherein the laser beam irradiation device includes:
a light-emitting body that has a plurality of light-emitting surfaces arranged in two directions, each of the light-emitting surfaces including a gathering of light-emitting points;
a first optical element group; and
a second optical element group having a plurality of apertures, the first optical element group and the second optical element group being disposed at different positions with respect to an emission direction of the light-emitting body,
wherein the first optical element group is divided in a first direction and a second direction different from the first direction into a plurality of first optical elements, each of the first optical elements has a deflecting characteristic that causes an incident light beam from the light-emitting body to be converted to an exit light beam deflected in the first direction, and adjacent ones of the first optical elements that are adjacent in the second direction have different deflecting characteristics in the first direction,
wherein at least one side of the second optical element group is divided at least in the first direction into a plurality of second optical elements each having an optical axis and having optical power in the second direction, and the optical axes of adjacent ones of the second optical elements have different heights in the second direction,
wherein the first optical elements include a plurality of constituent units each including at least two of the first optical elements that are continuous in the first direction, and the deflecting characteristics of the first optical elements are such that a group of exit light beams from each of the constituent units is deflected toward a corresponding one of the apertures of the second optical element group,
wherein the length of the second optical elements in the second direction is larger than the length of the first optical elements in the second direction,
wherein the optical axis of each of the second optical elements is decentered in the second direction from a central position, with respect to the second direction, of a corresponding one of the first optical elements, and
wherein the optical axes of the second optical elements are decentered toward the optical axis of the rotatable member.

4. An image forming apparatus comprising:
an image forming unit that forms an image;
a transfer unit that transfers the image formed by the image forming unit to a recording medium; and
a fixing unit that fixes the image transferred to the recording medium on the recording medium,
wherein the fixing unit includes:
a rotatable member that has an optical axis and allows a laser beam to pass therethrough;
an opposed member that is opposed to the rotatable member with a contact region formed between the opposed member and the rotatable member and co-operates with the rotatable member in the contact region to move and transport the recording medium; and
a laser beam irradiation device that is disposed outside the rotatable member and irradiates a predetermined position of the rotatable member with a laser beam,
wherein the laser beam irradiation device includes:
a light-emitting body that has a plurality of light-emitting surfaces arranged in two directions, each of the light-emitting surfaces including a gathering of light-emitting points;
a first optical element group; and
a second optical element group having a plurality of apertures, the first optical element group and the second optical element group being disposed at different positions with respect to an emission direction of the light-emitting body,
wherein the first optical element group is divided in a first direction and a second direction different from the first direction into a plurality of first optical elements, each of the first optical elements has a deflecting characteristic that causes an incident light beam from the light-emitting body to be converted to an exit light beam deflected in the first direction, and adjacent ones of the first optical elements that are adjacent in the second direction have different deflecting characteristics in the first direction,
wherein at least one side of the second optical element group is divided at least in the first direction into a plurality of second optical elements each having an optical axis and having optical power in the second direction, and the optical axes of adjacent ones of the second optical elements have different heights in the second direction,
wherein the first optical elements include a plurality of constituent units each including at least two of the first optical elements that are continuous in the first direction, and the deflecting characteristics of the first optical elements are such that a group of exit light beams from each of the constituent units is deflected toward a corresponding one of the apertures of the second optical element group,
wherein the length of the second optical elements in the second direction is larger than the length of the first optical elements in the second direction,
wherein the optical axis of each of the second optical elements is decentered in the second direction from a central position, with respect to the second direction, of a corresponding one of the first optical elements, and
wherein the optical axes of the second optical elements are decentered toward the optical axis of the rotatable member.
